(19) United States
(12) Patent Application Publication
(10) Pub. No.: US 2016/0125297 A1
(43) Pub. Date: May 5, 2016

(54) SYSTEM AND METHOD FOR SOLVING SPATIOTEMPORAL-BASED PROBLEMS

(71) Applicant: UMM AL-QURA UNIVERSITY, Makkah (SA)

(72) Inventors: Majid Saeed ALMARAASHI, Jeddah (SA); Hassan M. Khormi, Makkah (SA); Mohammad Kasim Ibrahim, Leicester (GB)

(73) Assignee: UMM AL-QURA UNIVERSITY, Makkah (SA)

(21) Appl. No.: 14/400,916

(22) PCT Filed: Oct. 30, 2014
(86) PCT No.: PCT/IB2014/002302

§ 371 Date: Nov. 13, 2014

(51) Int. Cl. G06N 5/04; G06N 7/00

(52) U.S. Cl. CPC G06N 5/045; G06N 7/005

(57) ABSTRACT

A system for adaptive intelligent decision making includes circuitry that receives a spatiotemporal problem that includes at least one of a spatial dimension and a temporal dimension. Problem data is assigned to a relative problem space that affects decisions to the spatiotemporal problem. Weighting factors are assigned to the problem data that indicate an effect of the problem data on the decisions to the spatiotemporal problem in order to control relationships between the problem data in the relative problem space. Decisions are determined to the spatiotemporal problem based on decisions between the problem data. Feedback is provided that is related to the decisions and an associated decision confidence factor.

### BACKGROUND

The “background” description provided herein is for the purpose of generally presenting the context of the disclosure. Work of the presently named inventor, to the extent it is described in this background section, as well as aspects of the description which may not otherwise qualify as prior art at the time of filing, are neither expressly nor impliedly admitted as prior art against the present disclosure.

Solving problems in the spatiotemporal dimension is a dynamic process that often involves analyzing large quantities of problem data to identify trends and make decisions. Fuzzy logic controllers can assist in processing the problem data by assigning fuzzy values that represent approximate values rather than fixed values. When compared to binary logic where values can be either true or false, fuzzy values can have a degree of truth ranging from zero to one.

### SUMMARY

In an exemplary embodiment, a system for adaptive intelligent decision making includes circuitry that receives a spatiotemporal problem that includes at least one of a spatial dimension and a temporal dimension. Problem data is assigned to a relative problem space that affects decisions to the spatiotemporal problem. Weighting factors are assigned to the problem data that indicate an effect of the problem data on the decisions to the spatiotemporal problem in order to control relationships between the problem data in the relative problem space. Decisions are determined to the spatiotemporal problem based on decisions between the problem data. Feedback is provided that is related to the decisions and an associated decision confidence factor.

The foregoing general description of exemplary implementations and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates an exemplary adaptive intelligent decision making system, according to certain embodiments;

FIG. 2A is an exemplary illustration of a relative problem space layer, according to certain embodiments;

FIG. 2B is an exemplary illustration of the problem variables, according to certain embodiments;

FIGS. 2C and 2D are exemplary illustrations of spatial variables, according to certain embodiments;

FIG. 2E is an exemplary illustration of the relative space knowledge, according to certain embodiments;

FIG. 3A is an exemplary illustration of a layered adaptive intelligent decision making system, according to certain embodiments;

FIG. 3B is an exemplary illustration of decision for a spatiotemporal problem, according to certain embodiments;

FIG. 4 is an exemplary flowchart of an adaptive fuzzy controller process, according to certain embodiments; and

FIG. 5 illustrates a non-limiting example of an computer, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

The present disclosure is directed to determining decisions to spatiotemporal problems. The word “decisions” used throughout the disclosure can also represent solutions, answers, and the like that describe results of processing data in an adaptive intelligent decision making system and is not meant to limit the scope of the disclosure.

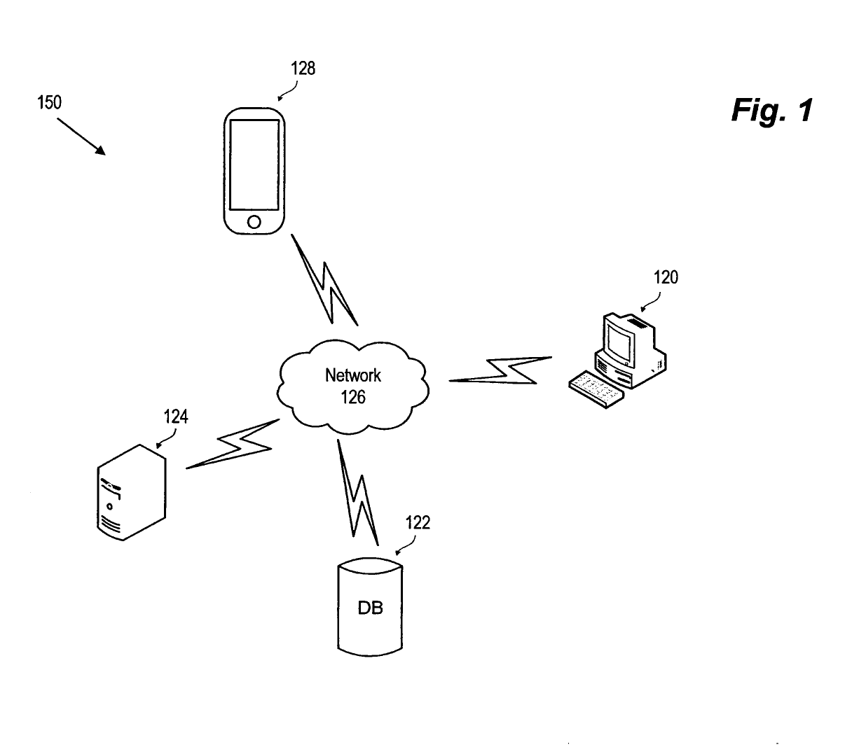

FIG. 1 illustrates an exemplary adaptive intelligent decision making system 150, according to certain embodiments. A computer 120 is shown connected to a server 124, database 122, and mobile device 128 via a network 126. The computer 120 acts as a client device that is connected to a server 124, a database 122, and a mobile device 128 via the network 126. The server 124 represents one or more servers connected to the computer 120, the database 122, and the mobile device 128 via the network 126. The database 122 represents one or more databases connected to the computer 120, the server 124, and the mobile device 128 via the network 126. The mobile device 128 represents one or more mobile devices connected to the computer 120, the server 124, and the database 122 via the network 126. The network 126 represents one or more networks, such as the Internet, connecting the computer 120, the server 124, the database 122, and the mobile device 128.

The computer 120 includes an interface, such as a keyboard and/or mouse, which allows a user to input information pertaining to a spatiotemporal problem which is then transmitted to the server 124 via network 126. The information pertaining to the spatiotemporal problem is received by the server 124 and is used by processing circuitry of the server 124 to develop a relative problem space layer.

The server 124 also includes processing circuitry that can determine decisions regarding spatiotemporal-based problems using a layered approach. For example, one spatiotemporal problem that can be solved by the adaptive intelligent decision making system 150 is an acceleration of malaria transmission across at-risk countries or regions. According to certain embodiments, a first layer of the adaptive intelligent decision making system 150 is a relative knowledge space layer that gathers problem data, such as the knowledge, information, and data components pertaining to the problem. According to the example of malaria transmission, the problem data can include seasonal climates based on region, mosquito concentration based on season, number of malaria cases per year and/or month, and the like. In some implementations, the problem data can be retrieved from the database 122 by the server 124. In addition, the server 124 can identify the problem data through a web crawling process that harvests information from the network 126, such as the internet, pertaining to the spatiotemporal-based problem as would be understood by one of ordinary skill in the art. In addition, the processing circuitry of the server 124 can classify the problem data as problem variables, spatiotemporal variables, fuzzy information, and fuzzy knowledge, and the like within the relative knowledge space layer.

The relative problem space layer can include a subset of one or more problems that are related to an overarching problem described by the relative problem space. For example, in the example of malaria transmission, the relative problem space can include one or more problems related to malaria transmission such as determining a cause of disease acceleration rate based on region, identifying resistance to malaria treatments, identifying causes for reductions in deaths from malaria, and the like. The first layer of the adaptive intelligent decision making system 150 can output problem-specific data and relationships between the problem-specific data based on the problem variables, spatiotemporal variables, fuzzy information, and fuzzy knowledge to a second layer of the adaptive intelligent decision making system 150.

In addition, in certain embodiments, the processing circuitry of the server 124 applies fuzzy logic controllers to the problem data in the second layer of the adaptive intelligent decision making system 150. The fuzzy logic controllers include one or more logic steps that are executed by software processes that determine the relationships between the knowledge, information, and data components in the first layer of the relative problem space by assigning weighting factors to the relationships between the variables in the problem space. The variables that have a larger effect on the decision are assigned larger weighting factors than the variables that have less of an effect on the decision. In addition, the weighting factors can be modified based on prior knowledge of the relationships between the variables and feedback from other layers in the adaptive intelligent decision making system 150. Updated weighted relationships between the variables and data of the adaptive intelligent decision making system 150 are output to a third layer where a decision is made to the spatiotemporal problem.

The third layer of the adaptive intelligent decision making system 150 is a decision layer for the spatiotemporal problem, according to certain embodiments. The decision regarding the spatiotemporal problem can be at least one quantifiable value that can be returned to the second layer of the adaptive intelligent decision making system 150 in a fuzzy form. In the example of the acceleration of malaria transmission throughout at-risk countries, a decision can be made that the rate of disease acceleration throughout a particular country is higher than expected norms and historical data. If this is the case, the decision layer can output a fuzzy value of “high” to the second layer of the adaptive intelligent decision making system 150. The fuzzy logic controllers in the second layer can in turn adjust the weights of the relationships between the variables in the relative problem space based on the decision. The decision to the spatiotemporal problem can also be output to a fourth layer of the adaptive intelligent decision making system 150 where a confidence is assigned to the decision.

The fourth layer of the adaptive intelligent decision making system 150 is a confidence layer, according to certain embodiments. The confidence layer assigns a level of confidence to the decision and outputs feedback regarding the level of confidence to the decision layer. In the example of the acceleration of malaria transmission throughout at-risk countries, the correlation of the variables in the relative problem space may be stronger for some countries than for other countries. For countries that have a strong correlation between variables in the relative knowledge space that factor into the decision, the degree of confidence applied to the decision may be higher than for countries that have a weaker correlation between variables in the relative knowledge space. Details regarding the adaptive intelligent decision making system 150 are discussed further herein.

As would be understood by one of ordinary skill in the art, based on the teachings herein, the mobile device 128 or any other external device could also be used in the same manner as the computer 120 to receive the information pertaining to the spatiotemporal problem at an interface and send the information to the server 124 and computer 120 via network 126 to establish the relative problem space layer. In one implementation, a user uses an application on his or her SmartPhone to identify the spatiotemporal problem of malaria transmission and specify spatiotemporal constraints such as a time or year or a location, such as Jeddah City. In an alternative embodiment, the server 124 can identify the spatiotemporal problem based on data stored in the database 122 or through a web scrawling process that harvests information from the network 126. In addition, the user can also view the results of the decision made by the adaptive intelligent decision making system 150 via the application on the SmartPhone.

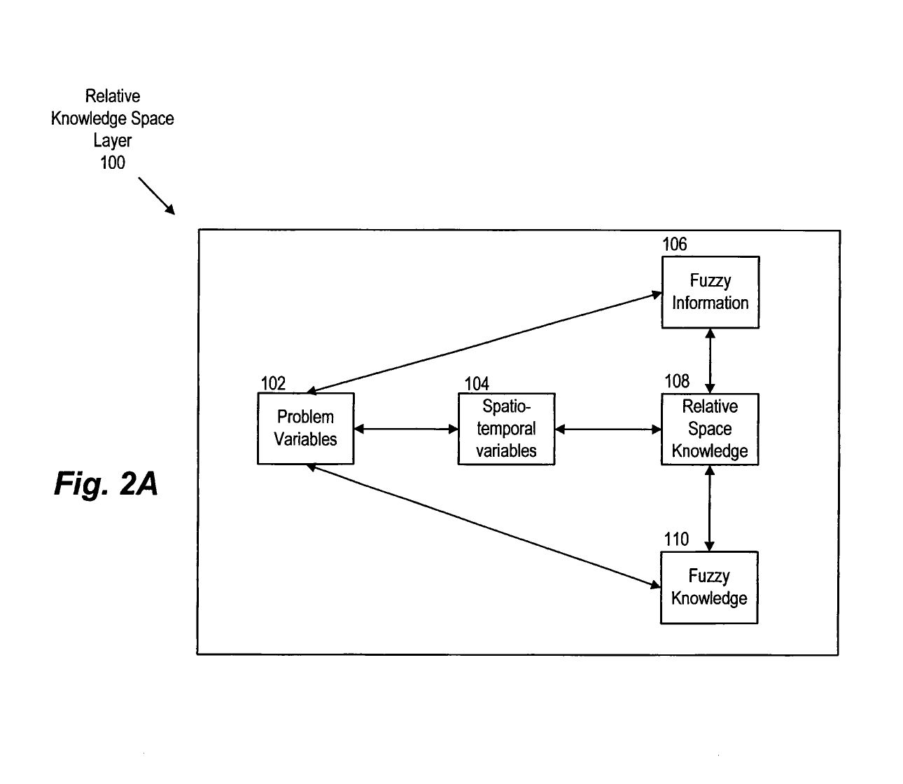

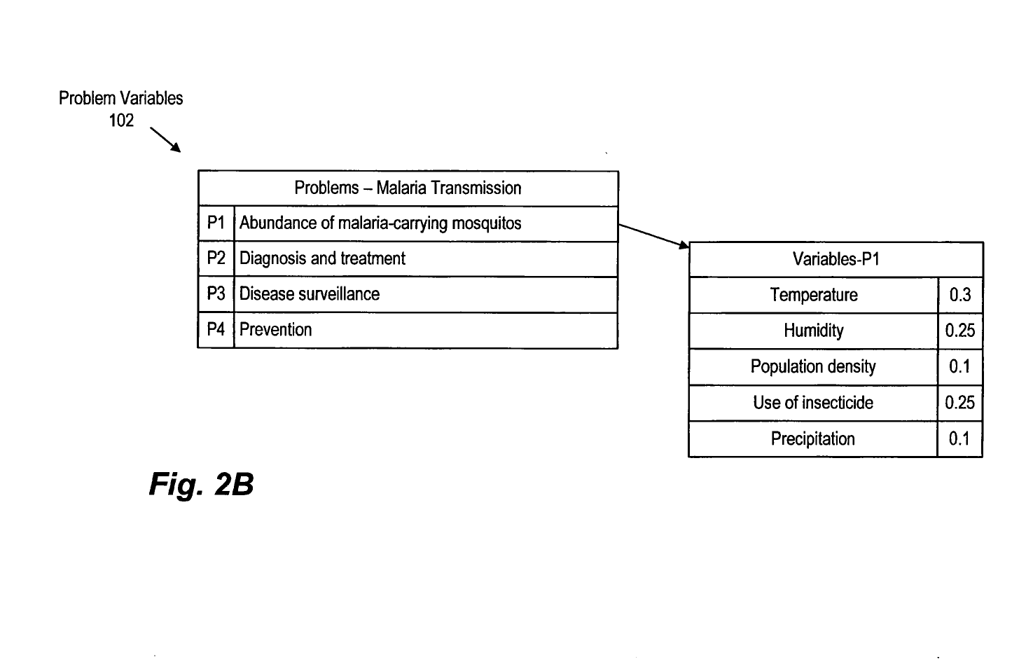

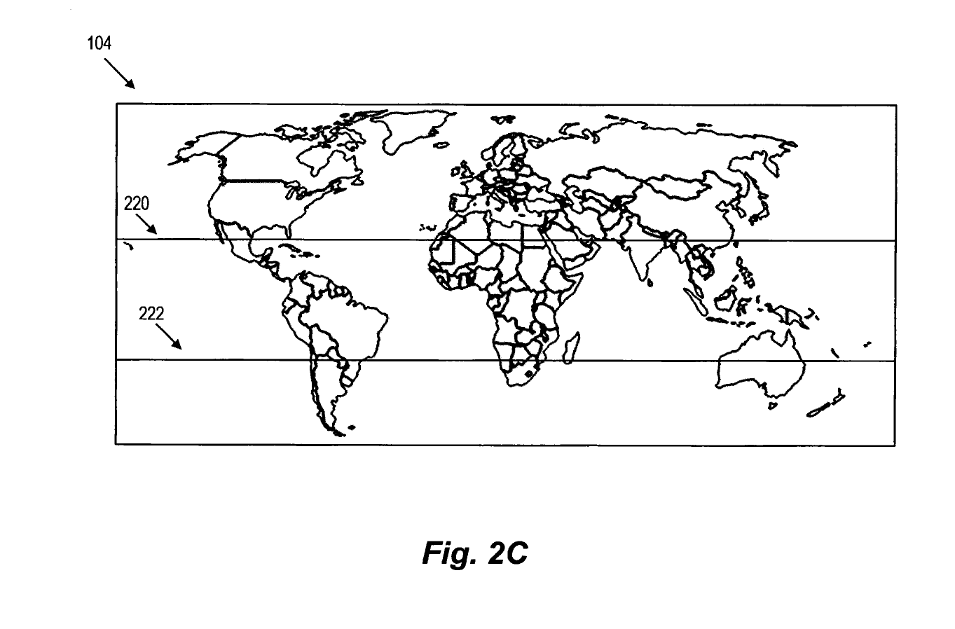

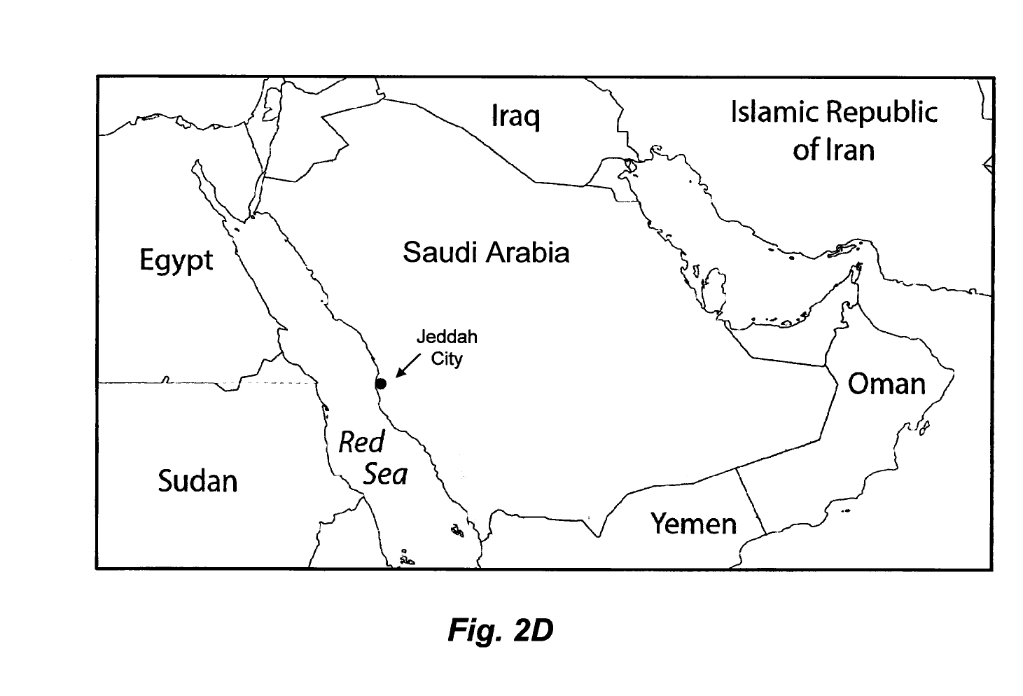

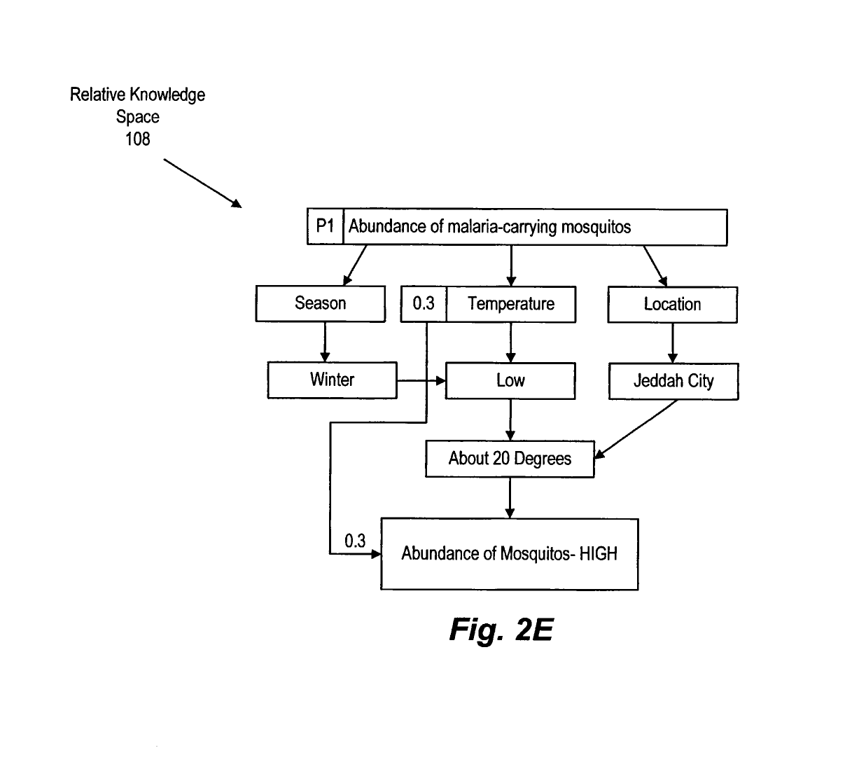

FIG. 2A is an exemplary illustration of a relative problem space layer 100, according to certain embodiments. The relative problem space layer 100 can be the first layer of an adaptive intelligent decision making system 150. In some implementations, the relative problem space layer 100 contains problem data pertaining to a problem or subset of problems, such as the causes, tracking, treatment, and/or prevention of malaria transmission. In some implementations, the data is organized into knowledge categories such as problem variables 102, spatiotemporal variables 104, fuzzy information, 106, fuzzy knowledge 110, and relative space knowledge 108.

FIG. 2B is an exemplary illustration of the problem variables 102, according to certain embodiments. In some implementations, problem data that can affect the one or more problems in the relative problem space layer 100 are stored in the database 122, which can be a meta-data warehouse, according to certain embodiments. The one or more problem variables 102 include the names of the one or more problems that are a part of the relative problem space layer 100 along with one or more associated variables that affect the outcomes of the one or more problems.

Weighting factors are assigned by the processing circuitry of the server 124 to the one or more associated variables that quantify how much the one or more problem variables 102 affect the problem decision. The weighting factors for the problem variables 102 may be stored in the database 122 and can be modified based on feedback from previous decisions made by the processing circuitry of the adaptive intelligent decision making system 150. In addition, the processing circuitry of the server 124 can determine the problem variables 102 and corresponding weighting factors via a problem variables controller. In certain embodiments, the problem variables 102 can be determined by the processing circuitry as functions of inputs from the fuzzy information 106, spatiotemporal variables 104, and fuzzy knowledge 110. Details regarding the determination of the weighting factors associated with the problem variables 102 will be discussed further herein.

One problem associated with malaria transmission is the abundance of malaria-carrying mosquitos in a region, which can be classified as problem P1. The abundance of malaria-carrying mosquitos in a region can be affected by one or more variables such as temperature of the region, humidity, amounts and/or types of insecticides used, and the like. For the variable of temperature of the region, a DVIW of 0.3 can be assigned by a problem variables controller that quantifies the affect that temperature has on the abundance of mosquitos in the region. According to some implementations, the problem data in the database 122 can be assigned weighting factors for each problem in the relative problem space layer 100. In certain implementations, the assigned weighting factors are fuzzy values between zero and one. In the example of FIG. 2B, the weighting factors for the variables of temperature, humidity, population density, use of insecticide, and precipitation add up to equal one. The problem variables 102 are output to a problem variables controller as will be discussed further herein.

Referring back to FIG. 2A, a plurality of spatiotemporal variables 104 can be included in the relative problem space layer 100. The spatiotemporal variables 104 can include data related to time or space that can affect the outcome of the one or more problems in the relative problem space layer 100. The processing circuitry of the server 124 determines the spatiotemporal variables 104 that are related to the problem being solved as a function of inputs from the problem variables 102 and the relative space knowledge 108. According to some implementations, real world problems are affected by time and space in a dynamic way. The processing circuitry assigns relationships between the spatiotemporal variables 104 and the problem variables 102 in order to determine how the spatiotemporal variables 104 affect the one or more problems in the relative problem space layer 100. In addition, the spatiotemporal variables 104 can be fuzzy in form, such as “close to point A,” or “after date B.”

For example, spatiotemporal variables 104 can include one or more stored maps with data points and/or features associated with the relative problem space layer 100. For the relative problem space layer 100 associated with malaria transmission, the spatiotemporal variables 104 can include detailed maps of the regions of the world that have the highest prevalence of malaria occurrences. FIGS. 2C and 2D are exemplary illustrations of spatiotemporal variables 104, according to certain embodiments. In the case of FIG. 2C, the database 122 can store longitude and latitude coordinates corresponding to countries or regions that have malaria-carrying mosquitos. In addition, the database 122 can store higher resolution spatiotemporal information for locations that are associated with the relative problem space layer 100. For example, since most malaria cases are reported in tropical locations, in some implementations, the database 122 can store higher resolution spatiotemporal variables 104 for locations south of latitude line 220 and north of latitude line 222.

FIG. 2D is an exemplary illustration of a part of the Eastern Mediterranean region of the world. In one implementation, the malaria transmission patterns of Saudi Arabia are studied so the geographical coordinates and topology of Saudi Arabia are included in the spatiotemporal variables 104. The spatiotemporal variables 104 can also be depicted in a fuzzy form such that they represent a value close or approximate to a desired value. An example of the fuzzy form of a spatial variable could be “near the coast of Nigeria” or “outside the city of Jeddah City.”

In addition, the spatiotemporal variables 104 can represent a status of time, such as an hour, day, week, month, year, or the like and can also be described in fuzzy form. Regarding the example of malaria transmission, the spatiotemporal variables 104 can include dates and/or times of confirming disease diagnosis, weather and climate characteristics related to time of year, demographic trends, socioeconomic factors, or the like. For example, a fuzzy time describing when a case of malaria was diagnosed could be “about 10:00 AM on Jul. 16, 2012.” In addition, the spatiotemporal variables 104 can include data from the database 122, data obtained from observational sensors that are connected to the server 124 via the network 126, or data generated from simulation models by the processing circuitry in the server 124.

Referring back to FIG. 2A, the relative problem space layer 100 can also include fuzzy information 106, which is problem-related processed data. The processing circuitry of the server 124 determines the fuzzy information 106 for the problem being solved as a function of inputs from the problem variables 102 and the relative space knowledge 108. For example, the processing circuitry can determine links between the problem data and the spatiotemporal problem while taking into account the weighting factors of the problem variables 102. The fuzzy information 106 is output to a fuzzy information controller as will be discussed further herein.

For example, one problem associated with malaria transmission is the abundance of disease-carrying mosquitos, which has a corresponding problem variable of temperature. In certain embodiments, the problem data in the database 122 can include recorded temperatures in the vicinity of Jeddah City with respect to time. In addition, an abundance of mosquitos can be correlated to the temperature of a location based on mosquito trapping statistics, geographic information system (GIS) modeling, or the like. For examples, fuzzy information 106 could include that an increase in temperature increases the abundance of mosquitos in Jeddah City in the winter season by 0.5 fuzzy degrees and 0.1 fuzzy degrees in the summer. In addition, a temperature of 38° Celsius (C) in Jeddah City can be assigned a fuzzy value of “high” based on the range of observed temperatures in Jeddah City and is included in the fuzzy information 106.

The relative problem space layer 100 can also include fuzzy knowledge 110, which includes knowledge rules or associations between data within the relative problem space layer 100, according to certain embodiments. The processing circuitry of the server 124 determines the fuzzy knowledge 110 related to the problem being solved as a function of inputs from the problem variables 102 and the relative space knowledge 108. The knowledge rules or associations can be stored in the database 122 or can be identified through a web crawling process that harvests information from the network 126, such as the internet, pertaining to the spatiotemporal-based problem. The knowledge rules or associations can also be input by a user at an interface at the computer 120.

For example, Table 1 below illustrates two sets of the fuzzy knowledge 110 that relate to mosquito abundance based on temperature, location, and time of year. For each problem in the relative problem space layer 100, the fuzzy knowledge 110 links the problem variables 102 and spatiotemporal variables 104. For example, the abundance of malaria-carrying mosquitos in Jeddah City can be studied in light of the problem variable of temperature along with the spatiotemporal variables 104. The fuzzy knowledge 110 is output to a fuzzy knowledge controller as will be discussed further herein.

TABLE 1

| | | | Mosquito |
|---|---|---|---|
| Temperature | Time of year | Place | Abundance |
| Low | About winter peak | Jeddah City | High |
| Medium | About winter peak | Near the coast | High |
| High | About summer peak | Jeddah City | Low |

In addition, the relative problem space layer 100 can also include relative space knowledge 108, which links each problem in the relative problem space layer 100 to the problem variables 102, spatiotemporal variables 104, fuzzy knowledge 110, and fuzzy information 106 associated with the problem. The processing circuitry of the server 124 determines the relative space knowledge 108 for the problem being solved as a function of inputs from the spatiotemporal variables 104, fuzzy knowledge 110, and fuzzy information 106. As will be discussed herein, the relative space knowledge 108 is output to a fuzzy relative space controller. The relative space knowledge 108 also receives feedback from the fuzzy relative space controller regarding the decision to previous problems as well as the weighting factors, fuzzy values, and relationships between the variables can be adjusted based on the decision.

FIG. 2E is an exemplary illustration of the relative space knowledge 108, determined in some embodiments as a function of problem-specific spatiotemporal variables 104, fuzzy knowledge 110, and fuzzy information 106, according to certain embodiments. For example, the spatiotemporal variables 104 provide the relative space knowledge 108 with variables related to time and space that are related to the problem being solved. The fuzzy knowledge 110 provides known rules or associations between data within the relative problem space layer 100 to the relative space knowledge 108. The fuzzy information 106 provides the relative space knowledge 108 with problem-related processed data.

In the example of studying the abundance of malaria-carrying mosquitos, one problem variable can be the temperature of a location. As shown in Table 1, the fuzzy knowledge 110 can include that in Jeddah city during a time of year that is “about winter peak,” the temperature can be identified as “low.” By linking the fuzzy knowledge 110 to the problem variables 102 that include raw temperature data stored in the database 122, the processing circuitry of the server 124 can determine a fuzzy temperature associated with the value of “low.” For example, the database 122 can store temperature data for a plurality of locations around the world, including Jeddah City. The processing circuitry can determine the fuzzy temperature by finding the lowest temperature or an average of the lowest temperatures recorded during the winter months in Jeddah City, which in some implementations can be “about twenty degrees.” By associating the fuzzy relative temperature of “low” with an actual fuzzy temperature of “about twenty degrees” in the relative space knowledge component 108, a plurality of locations with unequal temperatures and times of year can be compared with respect to the transmission of malaria throughout the world.

In the example, the correlation of the temperature of “about twenty degrees” with the mosquito abundance of “high” is output to the server 124 where the processing circuitry applies a fuzzy logic controller. In turn, for each of the other variables associated with the abundance of mosquitos, such as humidity, population density, use of insecticide, precipitation, and the like, are linked to the spatiotemporal variables 104, fuzzy knowledge 110, and fuzzy information 106 in the relative problem space layer 100, which are then output to the fuzzy logic controllers as will be discussed herein.

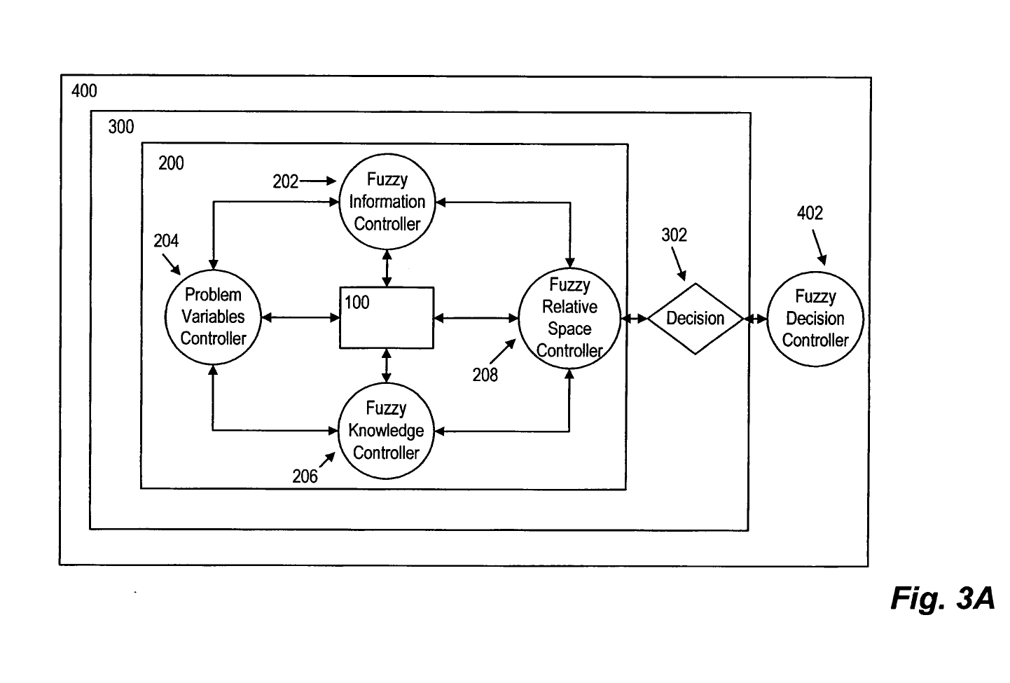

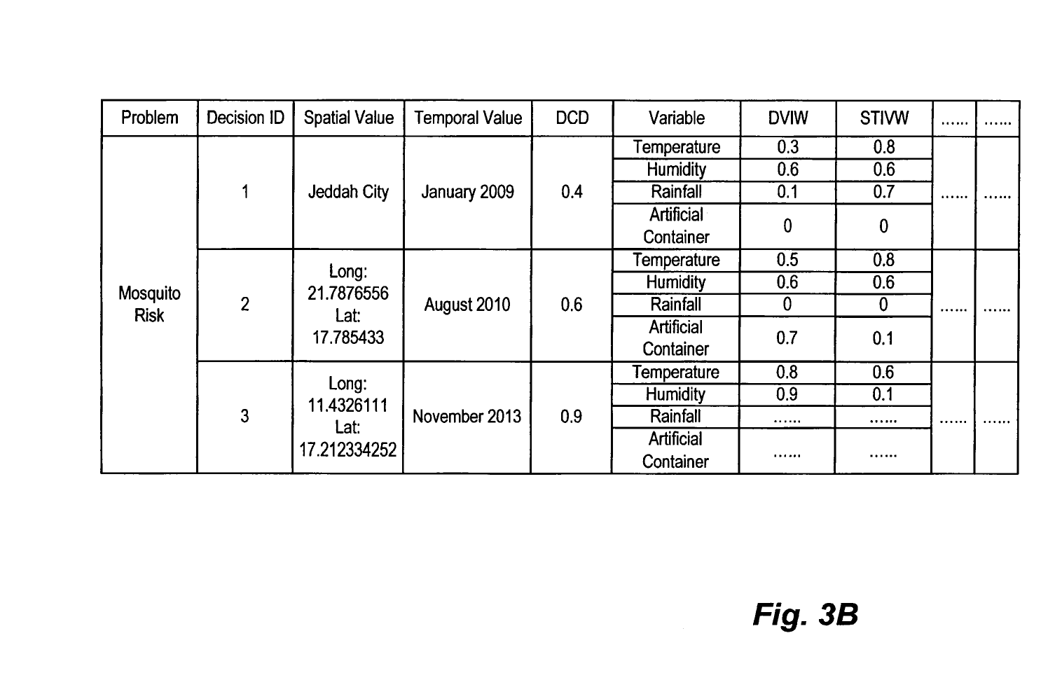

FIG. 3 is an exemplary illustration of a layered adaptive intelligent decision making system 150, according to certain embodiments. The layers of the adaptive intelligent decision making system 150 are interconnected so that the information gathered in relative problem space layer 100 can be controlled by the relative knowledge control layer 200. In turn, a decision layer 300 receives information from the relative knowledge control layer 200 to make a decision regarding a spatiotemporal problem and provide feedback to the relative knowledge control layer 200 and the relative problem space layer 100. In addition, a confidence control layer 400 can assign a confidence factor to the decision, which is also provided as feedback to the relative problem space layer 100 and the relative knowledge control layer 200.

The relative knowledge control layer 200 is a software layer that includes fuzzy logic controllers include one or more logic steps that are executed by the processing circuitry of the server 124 that control relationships between the problem data and variables. Examples of fuzzy logic controllers include the problem variables controller 204, the fuzzy information controller 202, the fuzzy knowledge controller 206, and a fuzzy relative space controller 208. According to certain embodiments, fuzzy logic controllers process data by assigning the data to partial membership in a set of data. For example, a fuzzy logic controller can take a temperature of a location and assign it a fuzzy value of “low” or “high.” In addition, with regard to spatial variables, the fuzzy logic controller can determine that a location one mile away from Jeddah City is “near Jeddah City.” In certain embodiments, using fuzzy data to determine decisions to spatiotemporal problems can allow data that may be imprecise or approximate to have an effect on the decision that is determined.

According to certain embodiments, the logic steps executed by the problem variables controller 204 determine the problem variables 102 associated with the relative problem space layer 100 that can include the subset of spatiotemporal-based problems as well as the variables associated with the problems. The problem variables controller 204 can determine the problems and variables based on queries of the problem data stored in the database 122 or through a web crawling process that harvests information from the network 126, such as the internet, pertaining to the spatiotemporal-based problems.

In certain embodiments, the logic steps executed by the problem variables controller 204 determine the weighting factors assigned to the problem variables 102. For example, as shown in FIG. 2B, for the problem of determining the abundance of malaria-carrying mosquitos, the variable of temperature is assigned the weighting factor of 0.3. In certain implementations, the weighting factors are fuzzy values assigned to the variables that have values between zero and one. The problem variables controller 204 can also convert the weighting factors to fuzzy numbers that represent an effect of the problem variables 102 on the spatiotemporal problem.

The problem variables controller 204 applies learning algorithms such as artificial neural networks, clustering, or the like to modify the weighting factors based on previous decisions made by the adaptive intelligent decision making system 150. In some implementations, decisions made by the adaptive intelligent decision making system 150 regarding other problems related to the abundance of malaria-carrying mosquitos. For example, previous decisions regarding the effects of temperature on mosquitos that carry other types of diseases, such as encephalitis, can be used as to determine the weighting factor for the effect of temperature on malaria-carrying mosquitos. In addition, the problem variables controller 204 can share information regarding the problem variables 102 and associated weighting factors with a fuzzy information controller 202 and a fuzzy knowledge controller 206.

In certain embodiments, inputs to the problem variables controller 204 include decision variable impact weights (DVIWs) and data variable quality weights (DVQWs) for each problem variable 102. The DVIWs are the weighting factors that quantify an impact of a variable on the problem decision and are fuzzy values between zero and one. The DVIWs are initialized in the confidence control layer 400 of the layered adaptive intelligent decision making system 150 by a user input or via determination by the processing circuitry. The DVQWs provide a quantization of completeness and robustness of the problem variables 102 and are fuzzy values between zero and one. For example, the quantity of problem data for each problem variable can affect the DVQW.

Outputs from the problem variables controller 204 include variable selection probability weights (VSPWs) for each problem variable 102. For example, the problem variable 102 of temperature related to the problem of mosquito abundance can be assigned an initial DVIW of 0.3 with a DVQW of 0.8. Fuzzy logic rules for determining the VPSW can be manually input by a user at the computer 120 or can be computed by the processing circuitry.

Table 2 is an exemplary matrix that illustrates how the processing circuitry determines the VPSW. For example, when the DVIW for an exemplary problem variable A is low, and the DVQW for the problem variable A is low, the VPSW for the problem variable A is very low. The VPSW can be translated to a fuzzy value between zero and one. For example, a VPSW of very low can have a fuzzy value between 0 and 0.15, and a VPSW of very high can have a fuzzy value between 0.85 and 1. VPSWs of low-medium, medium, and high-medium can have fuzzy values between 0.15 and 0.85 that increase as the VPSW increases

TABLE 2

| | | DVIW | | |
|---|---|---|---|---|
| VPSW | | Low | Medium | High |
| DVQW | Low | Very Low | Low-Medium | Medium |
| | Medium | Low-Medium | Medium | High-Medium |
| | High | Medium | High-Medium | Very High |

In certain embodiments, the fuzzy information controller 202 assigns problem data to the fuzzy information component 106. The fuzzy information controller 202 also manipulates the data in the fuzzy information component 106 based on feedback received from the problem variables controller 204 and the fuzzy relative space controller 208. For example, the relationship between an increasing abundance of malaria-carrying mosquitos in the summer due to an increase in temperature can be assigned an initial weighting factor of 0.1. The weighting factor can be modified based on feedback from the fuzzy relative space controller 208 regarding previous decisions made by the adaptive intelligent decision making system 150. The fuzzy information controller 202 can also convert the weighting factors to fuzzy numbers that represent an effect of the fuzzy information component 106 on the spatiotemporal problem.

In certain embodiments, inputs to the fuzzy information controller 202 include the DVIWs and spatiotemporal impact of variable weights (STIVWs) for each variable of the fuzzy information 106 component. The STIVWs provide a quantization of how much a change or modification in the spatiotemporal variables 104 affects the outcome of the problem and is provided as a fuzzy value between zero and one. The STIVW can be based on a maximum change in DVIW that occurs when the problem is assessed in other places other times.

Outputs from the fuzzy information controller 202 include a spatiotemporal impact on weighted direction (STIVWD) for each variable in the fuzzy information 106 component. The STIVWD is a weighted value between negative one and one that illustrates a direction of change (positive or negative) and relative magnitude of change in the DVIW based on the STIVW. Fuzzy logic rules for determining the STIVWD can be manually input by a user at the computer 120 or can be computed by the processing circuitry.

For example, Table 3 is an exemplary matrix that illustrates how the processing circuitry determines the STIVWD in the positive direction. For negative changes in the STIVWD, the table can be extended to include negative high values, negative low values, and the like. For the example of malaria-carrying mosquitoes, the DVIW for an exemplary problem variable of temperature is low when the impact of temperature on the problem being solved is low. In addition, the STIVW for temperature is low if a change location or time of year has a relatively small impact on the temperature. The resulting STIVWD for temperature is very low, which means that the problem variable of temperature is static with respect to the problem being solved. A positive STIVWD can be translated to a fuzzy value between zero and one, and a negative STIVWD can be translated to a fuzzy value between negative one and zero. For example, a positive STIVWD of very low can have a fuzzy value between 0 and 0.15, and a STIVWD of very-high can have a fuzzy value between 0.85 and 1.

TABLE 3

| | | DVIW | | |
|---|---|---|---|---|
| STIVWD | | Low | Medium | High |
| STIVW | Low | Very Low | Low-Medium | Medium |
| | Medium | Low-Medium | Medium | High-Medium |
| | High | Medium | High-Medium | Very High |

In some embodiments, the fuzzy information controller 202 redefines meanings of the problem data or how the data is perceived. For example, the problem of how mosquito abundance relates to the transmission of diseases, a temperature of 20° C. can have a fuzzy value of “high” for a city located north of the equator. However, for a city south of the equator during the month of February, the temperature of 20° C. may have a fuzzy value of “medium.” The fuzzy value of the temperature of 20° C. is changed based on the output from the fuzzy information controller 202.

In addition, the fuzzy knowledge controller 206 assigns problem data to the fuzzy knowledge 110 set. The fuzzy knowledge controller 206 also manipulates the data in the fuzzy knowledge 110 set based on feedback received from the problem variables controller 204 and the fuzzy relative space controller 208. For example, for each problem in the relative problem space layer 100, the fuzzy knowledge controller 206 links problem variables 102 and spatiotemporal variables 104 to develop the data associations in the fuzzy knowledge 110 set. As discussed previously, Table 1 demonstrates an example of fuzzy knowledge 110 that relates time of year, location, temperature, and abundance of mosquitos.

In certain embodiments, the fuzzy knowledge controller 206 can be responsible for assigning the fuzzy temperature values of “low,” “medium,” and “high,” as well as the fuzzy location values of “near Jeddah City” or “near the coast.” The fuzzy knowledge controller 206 can also assign weighting factors between zero and one to the fuzzy knowledge 110 to indicate strength of correlation between the fuzzy problem variables 102 and the fuzzy spatiotemporal variables 104. The fuzzy knowledge controller 206 can also convert the weighting factors to fuzzy numbers that represent an effect of the fuzzy knowledge 110 set on the spatiotemporal problem.

In certain embodiments, inputs to the fuzzy knowledge controller 206 include average rule decision variable impact weights (RDVIWs) and rule importance weights (RIWs) for each problem variable 102. The RDVIWs are the weighting factors that quantify an effect of the problem variables 102 on the knowledge rules of the fuzzy knowledge 110 set and are fuzzy values between zero and one. The RDVIWs are initialized in the confidence control layer 400 of the layered adaptive intelligent decision making system 150. The RIWs provide a quantization of an importance of the rules in the fuzzy knowledge 110 set and are fuzzy values between zero and one. For example, the knowledge rule of “if temperature is high and humidity is high, then mosquito abundance is high” can be have an RIW or 0.8. Fuzzy logic rules for determining the RIW can be manually input by a user at the computer 120 or can be computed by the processing circuitry. In certain embodiments, the fuzzy knowledge controller 206 computes an average of RIWs input by one or more users to determine the RIW used in determining the decision to the problem.

Outputs from the fuzzy knowledge controller 206 include rule selection probability weights (RSPWs) for each rule in the knowledge rule set. The RPSW shows a magnitude of impact that a knowledge rule has compared to other knowledge rules in the fuzzy knowledge 110 set. Fuzzy logic rules for determining the RPSW can be manually input by a user at the computer 120 or can be computed by the processing circuitry.

Table 4 is an exemplary matrix that illustrates how the processing circuitry determines the RPSW. For example, when the RDVIW for an exemplary variable A is low, and the RIW for the variable A is low, the RPSW for the problem variable A is very low. The RPSW can be translated to a fuzzy value between zero and one. For example, a RPSW of very low can have a fuzzy value between 0 and 0.15, and a RPSW of very high can have a fuzzy value between 0.85 and 1. RPSWs of low-medium, medium, and high-medium can have fuzzy values between 0.15 and 0.85 that increase as the RPSW increases.

TABLE 4

| | | RDVIW | | |
|---|---|---|---|---|
| RPSW | | Low | Medium | High |
| RIW | Low | Very Low | Low-Medium | Medium |
| | Medium | Low-Medium | Medium | High-Medium |
| | High | Medium | High-Medium | Very High |

The fuzzy relative space controller 208 is a primary interface between the relative knowledge control layer 200 and the decision layer 300 and can receive feedback regarding the decision and an associated confidence factor from a decision controller 302. In addition, the fuzzy relative space controller 208 can manipulate the relationships between the variables in the relative space knowledge 108 based on the outcome of a decision controller 302. For example, when a decision is made, a determination is also made regarding quality of the decision. The fuzzy relative space controller 208 can transmit the decision and the quality to the fuzzy information controller 202 and the fuzzy knowledge controller 206 in order to update the weighting factors of the fuzzy information 106 and the fuzzy knowledge 110 based on the outcome of the decision controller 302.

In certain embodiments, inputs to the fuzzy relative space controller 208 include the RPSWs for each rule in the knowledge set and an average variable selection probability weights (AVSPW) for each variable in the relative problem space layer 100. The AVSPW is an average of the VSPWs calculated by the problem variables controller 204 that are included in each rule. Outputs from the fuzzy relative space controller 208 include rule selection weights (RSWs) for each rule in the knowledge rule set related to the spatiotemporal problem.

Table 5 is an exemplary matrix that illustrates how the processing circuitry determines the RSW for each rule. For example, when the RPSW for an exemplary rule A is low, and the AVSPW for an exemplary variable A is low, the RSW is very low. The RSW can be translated to a fuzzy value between zero and one. For example, a RSW of very low can have a fuzzy value between 0 and 0.15, and a RSW of very high can have a fuzzy value between 0.85 and 1. RSWs of low-medium, medium, and high-medium can have fuzzy values between 0.15 and 0.85 that increase as the RSW increases.

TABLE 5

| | | RSPW | | |
|---|---|---|---|---|
| RSW | | Low | Medium | High |
| AVSPWA | Low | Very Low | Low-Medium | Medium |
| | Medium | Low-Medium | Medium | High-Medium |
| | High | Medium | High-Medium | Very High |

In certain implementations, the fuzzy relative space controller 208 applies a predetermined threshold to the RSWs to determine the rules that will be used in determining the decision. For example, if the predetermined threshold is set to 0.9, then all rules with a RSW of less than 0.9 will be omitted when determining the decision. The predetermined threshold can be determined based on DVIWs, quality of the data, and initial RSWs assigned to the rules in the fuzzy knowledge 110 set. The rules with RSW's that are greater than the predetermined threshold are sent to the decision layer 300 to determine the solution to the spatiotemporal problem.

The fuzzy relative space controller 208 can conduct two-way communications with the decision controller 302 in the decision layer 300. For example, in addition to receiving feedback regarding the decision and the associated confidence factor, the fuzzy relative space controller 208 can output problem-related information for the relative knowledge control layer 200, such as the RSWs greater than the predetermined threshold, to the decision layer 300. In certain embodiments, the problem-related information can also include other data, variables, weighting factors, and relationships within the relative problem space layer 100 that have been modified by the fuzzy logic controllers in the relative knowledge control layer 200 based on the spatiotemporal problem. The decision controller 302 can then determine the decision to the spatiotemporal problem and provide feedback to the relative knowledge control layer 200 and the relative problem space layer 100 based on the decision.

The decision controller 302 can determine the relative effect of the problem variables 102, spatiotemporal variables 104, fuzzy information 106, fuzzy knowledge 110, and relative space knowledge 110 on the decision that is made. The processing circuitry determines a decision inference degree (DID), which represents a level of confidence in a decision. In an implementation, the DID is determined by averaging the RSWs for all rules in the fuzzy knowledge 110 set that are calculated in the fuzzy knowledge space controller 208. The DID can be an input to determining a decision confidence degree (DCD) as will be discussed further herein. In certain embodiments, when two or more decision exist for a problem, the decision with a higher DCD is used, and the DID is updated based on the decision.

In certain embodiments, the relationships between the variables exhibited by the RSWs that are greater than the predetermined threshold are used to determine the decision. The decision is also based on parameters that include the selection of knowledge rules for the problem (RPSWs) as well as parameters associated with the relationships between the problem decision and variables, such as DVIWs and STIVWs. The decision can also be affected by the quality of the problem data, processes executed by the fuzzy logic controllers, and the spatiotemporal variables 104.

In one example, the problem in question deals with how the abundance of malaria-carrying mosquitos affects the transmission of malaria. Since the adaptive intelligent decision making system 150 can make evaluations across spatial domains, the decision controller 302 can output the effect of the abundance of mosquitos on malaria transmission on a worldwide, regional, national, or local level. In addition, since the adaptive intelligent decision making system 150 can make evaluations across temporal domains, the decision controller 302 can output the effect of mosquito abundance on malaria transmission during the different seasons of the year.

For example, in locations near Jeddah City, the problem variable of insecticide use may have a stronger correlation with malaria-carrying mosquito abundance than temperature. Based on the stronger correlation, the weighting factor associated with the insecticide use may be increased, and the weighting factor associated with temperature may be decreased by the problem variable controller 204. The relative effect that the components in the relative problem space layer 100 have on the decision controller 302 is returned as feedback via the fuzzy relative space controller 208 so that the fuzzy logic controllers in the relative knowledge control layer 200 can modify the weighting factors of the components in the relative problem space layer 100 based on the decision controller 302.

FIG. 3B is an exemplary illustration of decisions for a spatiotemporal problem of mosquito risk, according to certain embodiments. Three decisions are determined that include spatiotemporal values, variables, and weighting factors (e.g., DVIW, STIVW, etc.) that were used in determining the decision. The DCD for each decision is also output, which indicates a level of confidence in each decision. In some implementations, the decision with the highest DCD is used as the decision to the spatiotemporal problem.

Referring back to FIG. 3A, a confidence control layer 400 can include a fuzzy decision controller 402 that assigns confidence factors to the decisions determined at the decision controller 302. The confidence factors are provided as feedback to the relative problem space layer 100 and the relative knowledge control layer 200. For example, when decisions are determined at the decision controller 302, the processing circuitry can determine a cumulative strength of correlation between the variables in the relative problem space layer 100 and the decisions that are made. The cumulative strength of correlation can correspond to the decision confidence factors (DCDs), which are fuzzy values between zero and one. A DCD is computed for each decision determined at the decision controller 302.

In certain embodiments, the DCD is a function of the DID and an external feedback confidence degree (EFCD). The DID is based on an average of the RSWs for all rules in the fuzzy knowledge 110 set, and the EFCD is a confidence factor determined through experimental practice that illustrates an effectiveness of the decision in practice. A user can input feedback regarding the effectiveness of the decision at the computer 120, and the processing circuitry of the server 124 can determine the ECFD based on the input by the user. The ECFD is used to update the DCD for future iterations of decision making.

Table 6 is an exemplary matrix that illustrates how the processing circuitry determines the DCD for each decision made at the decision controller 302. For example, when the DID for an exemplary decision A is low, and the ECFD for the exemplary decision A is low, the DCD is very low. The DCD can be translated to a fuzzy value between zero and one. For example, a DCD of very low can have a fuzzy value between 0 and 0.15, and a DCD of very high can have a fuzzy value between 0.85 and 1. DCDs of low-medium, medium, and high-medium can have fuzzy values between 0.15 and 0.85 that increase as the DCD increases.

TABLE 6

| | | ECFD | | |
|---|---|---|---|---|
| DCD | | Low | Medium | High |
| DID | Low | Very Low | Low-Medium | Medium |
| | Medium | Low-Medium | Medium | High-Medium |
| | High | Medium | High-Medium | Very High |

Table 7 illustrates the relationships between the components of the adaptive intelligent decision making system 150.

TABLE 7

| From | To | Role |
|---|---|---|
| Spatiotemporal | Relative Space | Affects knowledge using specific space and time to |
| variables 104 | Knowledge 108 | get knowledge that is more suitable. |
| Relative Space | Spatiotemporal | Gets suitable space and time parameters (location, |
| Knowledge 108 | variables 104 | time, space, time lags, and the like). |
| Fuzzy Information | Relative Space | Returns associated information with specific |
| 106 | Knowledge 108 | problem. |
| Relative Space | Fuzzy | Gets associated information with specific problem |
| Knowledge 108 | Information 106 | to set up knowledge rules. |
| Fuzzy Knowledge | Relative Space | Returns associated knowledge with specific |
| 110 | Knowledge 108 | problem to determine what knowledge is still |
| | | needed. |
| Relative Space | Fuzzy Knowledge | Gets associated knowledge with specific problem |
| Knowledge 108 | 110 | as the basic form of relative space knowledge. |
| Problem Variables | Fuzzy | Returns the associated data that are the basis |
| 102 | Information 106 | components for specific information. |
| Fuzzy Information | Problem | Gets associated data that are needed for specific |
| 106 | Variables 102 | information. |
| Problem Variables | Fuzzy Knowledge | Returns the associated data that are needed for |
| 102 | 110 | specific knowledge. |
| Fuzzy Knowledge | Problem | Gets the associated data that are needed in specific |
| 110 | Variables 102 | knowledge rules. |
| Problem Variables | Spatiotemporal | Returns specific time and space parameters of |
| 102 | variables 104 | problem-specific data |
| Spatiotemporal | Problem | Allocates specific time and space parameters to |
| variables 104 | Variables 102 | problem-specific data (e.g., periodic lag, location |
| | | of data collection, etc.) |
| Fuzzy Information | Fuzzy | Controls selected information and weighting |
| Controller 202 | Information 106 | factors. |
| Fuzzy Information | Fuzzy | Returns selected information and current weighting |
| 106 | Information | factors. |
| | Controller 202 | |
| Fuzzy Knowledge | Fuzzy Knowledge | Controls the knowledge rules, structure parameters, |
| Controller 206 | 110 | and weighting factors. |
| Fuzzy Knowledge | Fuzzy Knowledge | Return knowledge representation structure |
| 110 | Controller 206 | parameters and weighting factors. |
| Problem Variables | Problem | Controls the selected problem-specific data and |
| Controller 204 | Variables 102 | weighting factors. |
| Problem Variables | Problem | Returns the selected problem-specific data and |
| 102 | Variables | weighting factors. |
| | Controller 204 | |
| Fuzzy Relative | Relative Space | Controls customization parameters for a specific |
| Space Controller | Knowledge 108 | problem after receiving feedback. |
| 208 | | |
| Relative Space | Fuzzy Relative | Returns customization parameters for a specific |
| Knowledge 108 | Space Controller | problem. |
| | 208 | |
| Fuzzy Information | Fuzzy Relative | Returns the structure parameters of information |
| Controller 202 | Space Controller | control for a specific problem. |
| | 208 | |
| Fuzzy Relative | Fuzzy | Controls the structure of information control |
| Space Controller | Information | parameters for a specific problem. |
| 208 | Controller 202 | |
| Fuzzy Knowledge | Fuzzy Relative | Returns the structure of knowledge representation |
| Controller 206 | Space Controller | control parameters for a specific problem. |
| | 208 | |
| Fuzzy Relative | Fuzzy Knowledge | Controls the structure of knowledge representation |
| Space Controller | Controller 206 | control parameters for a specific problem. |
| 208 | | |
| Problem Variables | Fuzzy Knowledge | Returns the associated data control parameters for |
| Controller 204 | Controller 206 | the problem-specific knowledge. |
| Fuzzy Knowledge | Problem | Returns data and weighting factors for problem- |
| Controller 206 | Variables | specific knowledge control. |
| | Controller 204 | |
| Problem Variables | Fuzzy | Returns associated data and weighting control |
| Controller 204 | Information | parameters that are associated with specific |
| | Controller 202 | information. |
| Fuzzy Information | Problem | Determines the associated data and weighting |
| Controller 202 | Variables | control parameters that are needed for the specific |
| | Controller 204 | information. |
| Fuzzy Relative | Decision 302 | Determines the decision after processing of data, |
| Space Controller | | spatiotemporal variables, knowledge, and |
| 208 | | controllers. |
| Decision 302 | Fuzzy Relative | Returns the decision information and feedback |
| | Space Controller | fuzzy weighting factors. |
| | 208 | |
| Fuzzy Decision | Decision 302 | Controls the decision through a feedback weighting |
| Controller 402 | | factor representing a level of accuracy of the |
| | | previous decision. |
| Decision 302 | Fuzzy Decision | Returns the current decision representing the |
| | Controller 402 | details of the previous decision. |

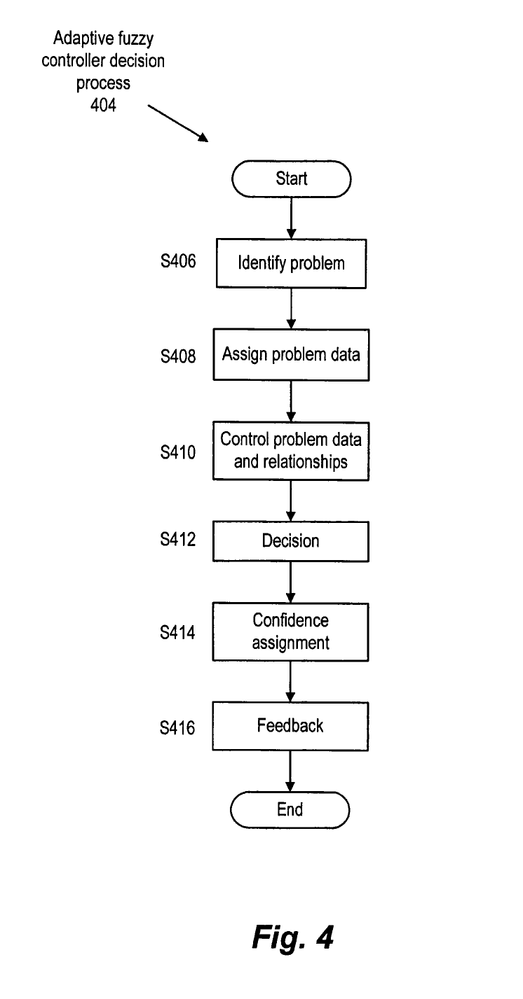

FIG. 4 is an adaptive fuzzy controller decision process 404, according to certain embodiments. At step S406, a spatiotemporal problem is identified. In some implementations, a user can input the problem via a keyboard at an interface at the computer 120 or the mobile device 128. The problem can also be identified by the processing circuitry of the server 124 based on the problem data stored in the database 122 or through a web crawling process that harvests information from the network 126. When the problem is identified, the processing circuitry can process problem data from the database 122 and/or execute a web crawling process to harvest information in order to develop a subset of related problems that affect the problem input by the user. For example, if the user inputs the problem of “malaria transmission” at the computer 120, the web crawling process can identify a subset of problems that includes the abundance of malaria-carrying mosquitos, diagnosis and treatment patterns, disease surveillance, prevention measures, and the like.

At step S408, problem data is assigned to the relative problem space layer 100 by the processing circuitry. In certain embodiments, the problem knowledge can include the problem variables 102, spatiotemporal variables 104, fuzzy information 106, fuzzy knowledge 110, and relative knowledge space knowledge 108. The problem variables controller 204 can assign the problem variables 102 by processing problem data that are stored in the database 122 that may affect the one or more problems in the relative problem space layer 100. In addition, the spatiotemporal variables 104 can include data related to time or space that can affect the outcome of the one or more problems in the relative problem space layer 100 that are depicted in a fuzzy form. The fuzzy information 106 can be assigned by the fuzzy information controller 202 and can include problem-related processed data. The fuzzy knowledge 110 can be assigned by the fuzzy knowledge controller 206 and can include known rules or associations between data within the relative problem space layer 100, according to certain embodiments.

At step S410, relationships between the variables in the relative problem space layer 100 are controlled by the at least one fuzzy logic controller in the relative knowledge control layer 200. For example, the weighting factors are assigned to the one or more problem variables 102 quantify how much the one or more problem variables 102 affect the problem decision. In addition, the weighting factors assigned to the fuzzy information 106, fuzzy knowledge 110, and relative space knowledge 108 can show how much of an effect the one or more problem variables have on the problem within spatiotemporal domains. For example, the effect of a temperature increase on the abundance of malaria-carrying mosquitos in the summer near Jeddah city can be assigned a weighting factor of 0.5.

At step S412, decisions are determined by the decision controller 302 regarding the spatiotemporal problem. The decision layer 300 receives the problem-related information from the relative knowledge control layer 200 via the fuzzy relative space controller 208. In certain embodiments, the problem-related information can include the data, variables, weighting factors (e.g., DVIWs, STIVWs, etc.), and relationships within the relative problem space layer 100 that have been modified by the fuzzy logic controllers in the relative knowledge control layer 200 based on the spatiotemporal problem. The decision controller 302 then determines one or more decisions pertaining to the spatiotemporal problem.

In one example, the problem in question deals with how the abundance of malaria-carrying mosquitos affects the transmission of malaria. Since the adaptive intelligent decision making system 150 can make evaluations across spatial domains, the decision controller 302 can output the effect of the abundance of mosquitos on malaria transmission on a worldwide, regional, national, or local level. In addition, since the adaptive intelligent decision making system 150 can make evaluations across temporal domains, the decision controller 302 can output the effect of mosquito abundance on malaria transmission during the different seasons of the year.

The decision controller 302 can also output the relative effect of the problem variables 102, spatiotemporal variables 104, fuzzy information 106, fuzzy knowledge, and relative space knowledge 110 on the decision that is made. For example, in locations near Jeddah City, the problem variable of insecticide use may have a stronger correlation with malaria-carrying mosquito abundance than temperature. Based on the stronger correlation, the weighting factor associated with insecticide use may be increased, and the weighting factor associated with temperature may be decreased by the problem variable controller 204.

At step S414, DCDs are assigned to the decisions by the fuzzy decision controller 402 in the confidence control layer 400 of the adaptive intelligent decision making system 150. In certain embodiments, when the decision are determined by the decision controller 302 is made, the processing circuitry can determine a cumulative strength of correlation between the variables in the relative problem space layer 100 and the decisions that are made. The cumulative strength of correlation can correspond to the DCD, which is a fuzzy value between zero and one.

At step S416, feedback from the decision layer 300 and the confidence control layer 400 is sent to the fuzzy logic controller layer 200. In certain embodiments, when the decisions are made, the relative effect that the components in the relative problem space layer 100 have on the decisions returned as feedback via the fuzzy relative space controller 208 so that the fuzzy logic controllers in the relative knowledge control layer 200 can modify the weighting factors of the components in the relative problem space layer 100 based on the decisions. In addition, the DCDs determined at step S414 can be provided as feedback to the fuzzy logic controllers in the relative knowledge control layer 200, which can then manipulate the weighting factors of the variables in the relative problem space layer 100.

According to certain embodiments, the adaptive intelligent decision making system 150 determines decisions to complex spatiotemporal-based problems. The adaptive intelligent decision making system 150 can determine interdependencies of decisions, data, spatiotemporal variables, information, and knowledge for specific spatiotemporal-based problems. Fuzzy logic controllers provide feedback to the adaptive intelligent decision making system 150 based on previous decision that are made, which enables users to develop solutions that are knowledge-based and adaptable based on dynamics that occur in spatiotemporal domains.

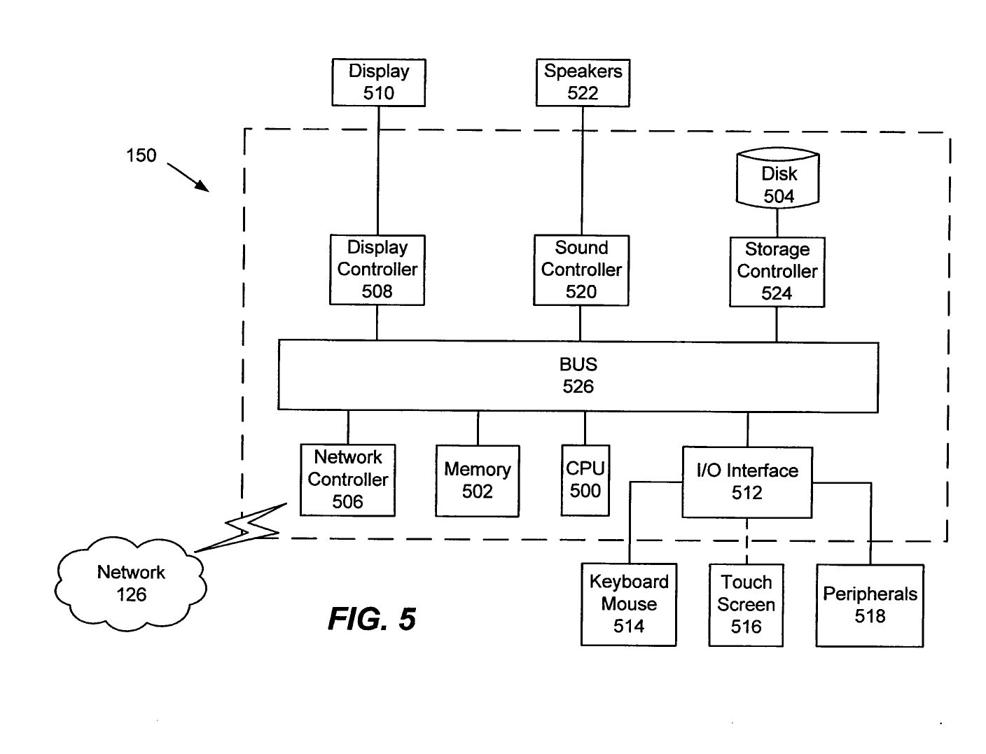

A hardware description of the adaptive intelligent decision making system 150 according to exemplary embodiments is described with reference to FIG. 5. The server 124 includes a CPU 500 that performs the processes described herein. The process data and instructions may be stored in memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 124 communicates, such as the computer 120.

Further, the claimed advancements may be provided as a utility application, background daemon, or component of an operating system, or combination thereof, executing in conjunction with CPU 500 and an operating system such as Microsoft Windows 7, UNIX, Solaris, LINUX, Apple MAC-OS and other systems known to those skilled in the art.

CPU 500 may be a Xenon or Core processor from Intel of America or an Opteron processor from AMD of America, or may be other processor types that would be recognized by one of ordinary skill in the art. Alternatively, the CPU 500 may be implemented on an FPGA, ASIC, PLD or using discrete logic circuits, as one of ordinary skill in the art would recognize. Further, CPU 500 may be implemented as multiple processors cooperatively working in parallel to perform the instructions of the inventive processes described above.

The server 124 in FIG. 5 also includes a network controller 506, such as an Intel Ethernet PRO network interface card from Intel Corporation of America, for interfacing with network 126. As can be appreciated, the network 126 can be a public network, such as the Internet, or a private network such as an LAN or WAN network, or any combination thereof and can also include PSTN or ISDN sub-networks. The network 126 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The server 124 further includes a display controller 508, such as a NVIDIA GeForce GTX or Quadro graphics adaptor from NVIDIA Corporation of America for interfacing with display 510 of the computer 120, such as a Hewlett Packard HPL2445w LCD monitor. A general purpose I/O interface 512 at the computer 120 or server 1234 interfaces with a keyboard and/or mouse 514 as well as a touch screen panel 516 on or separate from display 510. General purpose I/O interface 512 also connects to a variety of peripherals 518 including printers and scanners, such as an OfficeJet or DeskJet from Hewlett Packard.

A sound controller 520 is also provided in the adaptive intelligent decision making system 150, such as Sound Blaster X-Fi Titanium from Creative, to interface with speakers/microphone 522 thereby providing sounds and/or music.

The general purpose storage controller 524 connects the storage medium disk 504 with communication bus 526, which may be an ISA, EISA, VESA, PCI, or similar, for interconnecting all of the components of the adaptive intelligent decision making system 150. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

In other alternate embodiments, processing features according to the present disclosure may be implemented and commercialized as hardware, a software solution, or a combination thereof. In another exemplary hardware embodiment, a keyboard manufacturer could build new and secure keyboards that accept a smartcard that includes a security profile with one or more private keys, and circuitry in the keyboard could be configured to perform an adaptive fuzzy controller decision process in accordance with the present disclosure. Moreover, instructions corresponding to the adaptive fuzzy controller decision process in accordance with the present disclosure could be stored in a thumb drive that hosts a secure process.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, an implementation may be performed on modules or hardware not identical to those described. Accordingly, other implementations are within the scope that may be claimed.

The above disclosure also encompasses the embodiments listed below.

(1) A system for adaptive intelligent decision making, including: circuitry configured to: receive a spatiotemporal problem that includes at least one of a spatial dimension and a temporal dimension, assign problem data that affect one or more decisions to the spatiotemporal problem to a relative problem space, assign weighting factors indicating an effect of the problem data on the one or more decisions to the spatiotemporal problem to control relationships between the problem data in the relative problem space, determine the one or more decisions to the spatiotemporal problem based on the relationships between the problem data, and provide feedback related to the one or more decisions and an associated decision confidence factor.

(2) The system for adaptive intelligent decision making of (1), wherein the problem data in the relative problem space includes problem variables, spatiotemporal variables, fuzzy information, fuzzy knowledge, and relative space knowledge.

(3) The system for adaptive intelligent decision making of (1) or (2), wherein the circuitry is further configured to determine data variable impact weights for the problem variables based on effects of the problem variables on the one or more decisions.

(4) The system for adaptive intelligent decision making of any one of (1) to (3), wherein the circuitry is further configured to determine data variable quality weights for the problem variables based on at least one of a completeness and robustness of the problem variables.

(5) The system for adaptive intelligent decision making of any one of (1) to (4), wherein the circuitry is further configured to determine variable selection probability weights for the problem variables based on the data variable impact weights and the data variable quality weights.

(6) The system for adaptive intelligent decision making of any one of (1) to (5), wherein the circuitry is further configured to determine spatiotemporal impact weights for the problem variables based on effects of the spatiotemporal variables on the problem variables.

(7) The system for adaptive intelligent decision making of any one of (1) to (6), wherein the circuitry is further configured to determine spatiotemporal impacts on the variable weight direction based on directions and magnitudes of change in the data variable impact weights when the spatiotemporal variables are modified.

(8) The system for adaptive intelligent decision making of any one of (1) to (7), wherein the fuzzy knowledge includes one or more knowledge rules or associations between the problem data in the relative problem space.

(9) The system for adaptive intelligent decision making of any one of (1) to (8), wherein the circuitry is further configured to determine average rule decision variable impact weights for the fuzzy knowledge based on an effect of the problem variables on the one or more knowledge rules.

(10) The system for adaptive intelligent decision making of any one of (1) to (9), wherein the circuitry is further configured to determine rule impact weights for the one or more knowledge rules based on effects of the one or more knowledge rules on the one or more decisions.

(11) The system for adaptive intelligent decision making of any one of (1) to (10), wherein the circuitry is further configured to determine rule selection probability weights for the one or more knowledge rules based on the average rule decision variable impact weights and the rule impact weights.

(12) The system for adaptive intelligent decision making of any one of (1) to (11), wherein the circuitry is further configured to determine rule selection probability weights based on the rule selection probability weights and average of probability selection weights for the problem variables in the one or more knowledge rules.

(13) The system for adaptive intelligent decision making of any one of (1) to (12), wherein the circuitry is further configured to determine the one or more decisions based on one or more rule selection probability weights that are greater than a predetermined threshold.

(14) The system for adaptive intelligent decision making of any one of (1) to (13), wherein the one or more decisions include spatiotemporal values, variables, and the weighting factors that affected the one or more decisions.

(15) The system for adaptive intelligent decision making of any one of (1) to (14), wherein the circuitry is further configured to determine the decision confidence factor based on a decision inference degree and an external feedback confidence degree.

(16) The system for adaptive intelligent decision making of any one of (1) to (15), wherein the circuitry is further configured to determine the decision inference degree based on a confidence level in the one or more decisions.

(17) The system for adaptive intelligent decision making of any one of (1) to (16), wherein the circuitry is further configured to determine the external feedback confidence degree based on a measured effectiveness of the one or more decisions in practice.

(18) The system for adaptive intelligent decision making of any one of (1) to (17), wherein the circuitry is further configured to modify the problem data in the relative problem space based on the feedback regarding the one or more decisions.

(19) A non-transitory computer-readable medium having computer-readable instructions thereon which when executed by a computer cause the computer to perform a method for solving spatiotemporal-based problems, the method including: receiving a spatiotemporal problem that includes at least one of a spatial dimension and a temporal dimension; assigning problem data that affect one or more decisions to the spatiotemporal problem to a relative problem space; assigning weighting factors indicating an effect of the problem data on the one or more decisions to the spatiotemporal problem to control relationships between the problem data in the relative problem space; determining the one or more decisions to the spatiotemporal problem based on the relationships between the problem data; and providing feedback regarding the decision and an associated decision confidence factor.

(20) A method for solving spatiotemporal-based problems, including: receiving, at least one server, a spatiotemporal problem that includes at least one of a spatial dimension and a temporal dimension; assigning, at the at least one server, problem data that affect one or more decisions to the spatiotemporal problem to a relative problem space; assigning, at the at least one server, weighting factors indicating an effect of the problem data on the one or more decisions to the spatiotemporal problem to control relationships between the problem data in the relative problem space; determining, at the at least one server, the one or more decisions to the spatiotemporal problem based on the relationships between the problem data; and providing, at the at least one server, feedback regarding the decision and an associated decision confidence factor.

1. A system for adaptive intelligent decision making, comprising:
circuitry configured to:
receive a spatiotemporal problem that includes at least one of a spatial dimension and a temporal dimension,
assign problem data that affect one or more decisions to the spatiotemporal problem to a relative problem space,
assign weighting factors indicating an effect of the problem data on the one or more decisions to the spatiotemporal problem to control relationships between the problem data in the relative problem space,
determine the one or more decisions to the spatiotemporal problem based on the relationships between the problem data, and
provide feedback related to the one or more decisions and an associated decision confidence factor.

2. The system for adaptive intelligent decision making of claim 1, wherein the problem data in the relative problem space includes problem variables, spatiotemporal variables, fuzzy information, fuzzy knowledge, and relative space knowledge.

3. The system for adaptive intelligent decision making of claim 2, wherein the circuitry is further configured to determine data variable impact weights for the problem variables based on effects of the problem variables on the one or more decisions.

4. The system for adaptive intelligent decision making of claim 3, wherein the circuitry is further configured to determine data variable quality weights for the problem variables based on at least one of a completeness and robustness of the problem variables.

5. The system for adaptive intelligent decision making of claim 4, wherein the circuitry is further configured to determine variable selection probability weights for the problem variables based on the data variable impact weights and the data variable quality weights.

6. The system for adaptive intelligent decision making of claim 3, wherein the circuitry is further configured to determine spatiotemporal impact weights for the problem variables based on effects of the spatiotemporal variables on the problem variables.

7. The system for adaptive intelligent decision making of claim 6, wherein the circuitry is further configured to determine spatiotemporal impacts on the variable weight direction based on directions and magnitudes of change in the data variable impact weights when the spatiotemporal variables are modified.

8. The system for adaptive intelligent decision making of claim 2, wherein the fuzzy knowledge includes one or more knowledge rules or associations between the problem data in the relative problem space.

9. The system for adaptive intelligent decision making of claim 8, wherein the circuitry is further configured to determine average rule decision variable impact weights for the fuzzy knowledge based on an effect of the problem variables on the one or more knowledge rules.

10. The system for adaptive intelligent decision making of claim 9, wherein the circuitry is further configured to determine rule impact weights for the one or more knowledge rules based on effects of the one or more knowledge rules on the one or more decisions.

11. The system for adaptive intelligent decision making of claim 10, wherein the circuitry is further configured to determine rule selection probability weights for the one or more knowledge rules based on the average rule decision variable impact weights and the rule impact weights.

12. The system for adaptive intelligent decision making of claim 11, wherein the circuitry is further configured to determine rule selection probability weights based on the rule selection probability weights and average of probability selection weights for the problem variables in the one or more knowledge rules.

13. The system for adaptive intelligent decision making of claim 1, wherein the circuitry is further configured to determine the one or more decisions based on one or more rule selection probability weights that are greater than a predetermined threshold.

14. The system for adaptive intelligent decision making of claim 1, wherein the one or more decisions include spatiotemporal values, variables, and the weighting factors that affected the one or more decisions.

15. The system for adaptive intelligent decision making of claim 1, wherein the circuitry is further configured to determine the decision confidence factor based on a decision inference degree and an external feedback confidence degree.

16. The system for adaptive intelligent decision making of claim 15, wherein the circuitry is further configured to determine the decision inference degree based on a confidence level in the one or more decisions.

17. The system for adaptive intelligent decision making of claim 16, wherein the circuitry is further configured to determine the external feedback confidence degree based on a measured effectiveness of the one or more decisions in practice.

18. The system for adaptive intelligent decision making of claim 1, wherein the circuitry is further configured to modify the problem data in the relative problem space based on the feedback regarding the one or more decisions.

19. A non-transitory computer-readable medium having computer-readable instructions thereon which when executed by a computer cause the computer to perform a method for solving spatiotemporal-based problems, the method comprising:
receiving a spatiotemporal problem that includes at least one of a spatial dimension and a temporal dimension;
assigning problem data that affect one or more decisions to the spatiotemporal problem to a relative problem space;
assigning weighting factors indicating an effect of the problem data on the one or more decisions to the spatiotemporal problem to control relationships between the problem data in the relative problem space;
determining the one or more decisions to the spatiotemporal problem based on the relationships between the problem data; and
providing feedback regarding the decision and an associated decision confidence factor.

20. A method for solving spatiotemporal-based problems, comprising:
receiving, at least one server, a spatiotemporal problem that includes at least one of a spatial dimension and a temporal dimension;
assigning, at the at least one server, problem data that affect one or more decisions to the spatiotemporal problem to a relative problem space;
assigning, at the at least one server, weighting factors indicating an effect of the problem data on the one or more decisions to the spatiotemporal problem to control relationships between the problem data in the relative problem space;
determining, at the at least one server, the one or more decisions to the spatiotemporal problem based on the relationships between the problem data; and
providing, at the at least one server, feedback regarding the decision and an associated decision confidence factor.
